(19) United States
(12) Patent Application Publication
(10) Pub. No.: US 2015/0129269 A1
(43) Pub. Date: May 14, 2015

(54) IMPACT DEVICE AND METHOD OF DISMOUNTING THE SAME

(71) Applicant: SANDVIK MINING AND CONSTRUCTION OY, Tampere (FI)

(72) Inventors: Timo MUUTTONEN, Tampere (FI); Mikko HÄMÄLÄINEN, Tampere (FI); Lars KANDELIN, Tampere (FI); Teemu HIETAKARI, Tampere (FI)

(21) Appl. No.: 14/539,638

(22) Filed: Nov. 12, 2014

(30) Foreign Application Priority Data
Nov. 13, 2013 (EP) 13192673.5

(51) Int. Cl. B25D 9/02; E21B 6/00; E21B 1/04; B25D 17/24; B25D 9/06

(52) U.S. Cl. CPC B25D 9/02; B25D 17/245; B25D 9/06; E21B 1/04; E21B 6/00
USPC 173/105; 173/206; 29/426.5

(57) ABSTRACT

An impact device and a method of dismounting an impact device from a breaking device is disclosed. The impact device includes a bush having a percussion piston disposed therein. The impact device is arranged inside an impact device space formed in a frame of a breaking device. The percussion piston is provided with a pull shoulder allowing a dismounting force in a return direction to be transmitted from the percussion piston to the bush. Thus, the bush is extracted from the frame by means of the percussion piston.

### RELATED APPLICATION DATA

This application claims priority under 35 U.S.C. §119 to EP Patent Application No. 13192673.5, filed on Nov. 13, 2013, which the entirety thereof is incorporated herein by reference.

### TECHNICAL FIELD

The present disclosure relates to an impact device. The impact device is intended to provide impact pulses to a tool for breaking material being operated. The impact device includes a percussion piston, which is a reciprocating object allowed to move in an impact direction and a return direction. The disclosure further relates to a method of dismounting an impact device from a breaking device.

### BACKGROUND

In mines and at other work sites, drilling machines are used for drilling bore holes into rock surfaces and soil. A drilling tool may be connected to a drilling machine. The drilling machine has a rotating device for rotating the tool during drilling. The drilling machine also includes a percussion device for generating impact pulses to the tool.

The drilling machine is used in harsh conditions and thereby needs to be serviced periodically. At least bearings and seals wear during the use. In order to execute proper service procedures, the impact device has to be dismounted. However, dismounting of the present impact devices is found to be difficult and time consuming.

### SUMMARY

An aspect of the disclosure is to provide an improved impact device. A further aspect is to provide an improved method of dismounting an impact device from a breaking device.

The impact device according to the disclosure is characterized in that the percussion piston includes at least one pull shoulder, which has an outer diameter and further a first counter surface facing towards the return direction. The inner surface of the bush is provided with at least one counter section located between the pull shoulder and a rear end of the bush. The counter section includes an inner diameter and further a second counter surface facing towards the impact direction. The outer diameter of the pull shoulder is greater than the inner diameter of the counter section. The first counter surface of the pull shoulder and the second counter surface of the counter section are allowed to abut when the percussion piston is pulled in the return direction.

The method according to the disclosure is characterized by generating an external force in the return direction of the impact device and directing the external force to the percussion piston during the dismounting; and extracting the bush outside the frame by means of the percussion piston.

An idea of the disclosed solution is that the impact device, or percussion device, includes at least a percussion piston and a bush inside which the percussion piston is arranged. The bush is supported to a frame of a breaking machine, which may be a rock drilling machine or a breaking hammer, for example. The bush may be extracted by means of the percussion piston. Then an external force is directed to the percussion piston in a return direction of the impact device. The percussion piston directs the external force effect to the bush without the need of directing any external forces directly to the bush. Mutual dimensions of supporting surfaces between the frame and the bush are dimensioned to allow the bush to be moved in the return direction. Furthermore, mutual dimensions of inner surfaces of the bush and outer surfaces of the percussion piston are dimensioned so that the percussion piston cannot be pulled in the reverse direction completely out of an inner space of the bush. In the disclosed solution the percussion piston also serves as an extraction tool in addition to its primary purpose, namely generating impact pulses to a breaking tool.

Accordingly, dismounting of the impact device is fast and easy. The disclosed solution allows service operations to be carried out in operating conditions since only the rear cover of the breaking device needs to be removed. Thereby dirt and other impurities do not get inside the breaking device as easily as compared to solutions where the whole structure of the breaking device needs to be dismounted when serviced.

According to an embodiment, the impact device includes one or more front bearings at the front end portion of the percussion piston for supporting the percussion piston to the bush. In addition, the pull shoulder of the percussion piston is located between the front bearing and the rear end of the percussion piston.

According to an embodiment, the impact device includes a bush and an inner surface of the bush is provided with one or more counter sections. The counter section of the bush is located between a pull shoulder of a percussion piston and a rear end of the bush. Further, the counter section has an inner diameter, which is dimensioned so that it is smaller than any other inner diameter of the bush.

According to an embodiment, the pull shoulder and the counter section are allowed to form a closed pressure space between the percussion piston and the bush when the percussion piston is moved to an extreme operational position in the return direction. The formed closed pressure space serves as end cushioning in the return direction during an operating cycle of the impact device. Thanks to this embodiment, the pull shoulder is usable not only when dismounting the impact device but also during the normal use and work cycle of the impact device. The basic structure of the impact device may allow the above discussed dismounting feature without any specific shoulders or structural features.

According to an embodiment, the pull shoulder is located at a front most pressure chamber of the impact device.

According to an embodiment, the pull shoulder is provided with a cushioning surface facing the impact direction. Then the pull shoulder may serve also as end cushioning when the percussion piston is moved to its operational extreme position in the impact direction.

According to an embodiment, the impact device includes at least one control valve for controlling pressure medium affecting working pressure surfaces of the percussion device. The control valve is a sleeve-like piece and is located in an annular space between the percussion piston and the bush.

According to an embodiment, the outer surface of the bush is provided with two circular support surfaces locating at an axial distance from each other, and both have outer diameters. Thus, the front end of the bush is provided with a first support surface and the rear end is provided with a second support surface. The support surfaces have a limited axial length, whereby the first support surface has a first axial length and the second support surface has a second axial length. The outer surface of the bush is also provided with an intermediate section between the first support surface and the second support surface. The intermediate section also has a limited axial length. The diameter of the first support surface is smaller than the diameter of the second support surface, and further the diameter of the intermediate section is smaller than the diameter of the second support surface. In other words, the front end of the bush has the smallest outer diameter, the intermediate section has the second smallest outer diameter, and the rear end of the bush has the greatest outer diameter. This means that the outer surface of the bush tapers stepwise towards the front end.

Because of the shapes and dimensions of the outer surface of the bush, mounting of the bush is facilitated as the narrow front end portion of the bush serves as a guide portion during installation. Since the front end of the bush has the smallest diameter it is substantially easier to push it into its correct position, as compared to a bush having a uniform diameter throughout the whole length of the bush. The bush with the uniform outer diameter will stick easily. Thus, this harmful effect may now be avoided.

According to an embodiment, the outer surface of the bush has support surfaces at its end portions and an intermediate section between the support surfaces. The support surfaces of the bush are supported to support surfaces of a frame of the breaking device. Between the intermediate portion and the frame of the breaking device is a clearance. In other words, the intermediate portion is not supported to the frame of the breaking device. Due to the intermediate section and the clearance, mounting of the bush and the whole impact device is facilitated.

According to an embodiment, the outer surface of the intermediate section of the bush has one or more axial flow passages or channels. The outer surface of the intermediate section may comprise one or more grooves.

According to an embodiment, the outer surface of the intermediate section of the bush has a splined configuration, whereby it has several axial splines and flow channels between adjacent splines.

According to an embodiment, the bush has a total axial length that is at least double compared to the greatest axial length of either of the first support surface and the second support surface. This embodiment further facilitates mounting of the bush and the whole impact device inside the frame of the breaking device.

According to an embodiment, the disclosed impact device is applied in a rock drilling machine. The rock drilling machine includes a frame, an impact device arranged inside the frame and a rotating device. The impact device is arranged to generate impact pulses to a drilling tool connectable to the front end of the drilling machine. The rotation device is arranged to turn the tool relative to its longitudinal axis during drilling.

According to an embodiment, the disclosed solution is applied in top-hammer drilling.

According to an embodiment, the disclosed solution is applied in a down-the-hole percussion device. In the so called DTH-drilling the percussion device is located inside a bore hole. The percussion device and a rotating device are located at opposite ends of the drilling equipment. The down-the-hole percussion device is also known as a DTH-hammer.

According to an embodiment, the disclosed solution is applied in a breaking hammer by means of which rock material or any other hard material may be broken without the use of rotating tool. The breaking device may be an auxiliary device connectable to a boom of an excavator, for example. The breaking hammer may also be called a hydraulic hammer. The breaking hammer includes a frame and an impact device arranged inside the frame. Since the impact device may be removed and serviced in a fast and easy manner, operational efficiency of the breaking device may be improved.

According to an embodiment, the frame of the rock drilling machine or the breaking hammer includes a rear end, which is provided with a rear cover. The rear cover may be removed where after the bush inside the frame may be extracted by means of the percussion piston.

According to an embodiment, the impact device is dismounted as one single piece, which includes not only the bush and the percussion piston, but also the bearings and seals between the percussion piston and the bush. The impact device having all the necessary components is thus a kind of impact device package or cartridge that may be handled as one unit. Due to this embodiment, all components needing service may be removed simultaneously and by means of one extracting movement. Then the worn or damaged impact device package may be changed to a new complete impact package faster, or alternatively the worn or damaged components of the removed impact device package may be replaced.

According to an embodiment, the impact device is dismounted when the frame of the breaking device is still fastened to a work machine. Due to this embodiment a rock drilling machine may be serviced without removing it from a feed beam. On the other hand, a breaking hammer may be serviced without removing it from a boom of an excavator or similar work machine. When the servicing may be executed without removal of the breaking device, substantial savings in service time may be achieved.

According to an embodiment, an axial force is generated to the bush so that the bush is pressed towards the rear cover during the use of the impact device. This ensures that the bush is positioned accurately to a position defined by the rear cover, which is rigidly fastened to a frame of the breaking device. The bush may have one or more working pressure surfaces directed towards the rear cover and produce the mentioned axial force when pressure of pressure medium affects the mentioned one or more working pressure surfaces. The bush is provided with greater pressure surface areas acting in the return direction, as compared to pressure surface areas acting in opposite impact direction. Due to this embodiment the bush and pressure ducts of the bush are positioned accurately to a designed position, whereby the impact device operates as designed.

According to an embodiment, a fitting tool or adapter is fastened to the rear end of the percussion piston at least for the duration of dismounting the impact device. The fitting tool may be utilized during assembling the impact device, too.

According to an embodiment, the rear end portion of the percussion piston is provided with at least one fastening point allowing a separate fitting tool to be connected to the percussion piston. Due to the preformed fastening point, connection of a fitting tool is facilitated. Further, the connection between the fitting tool and the percussion piston is secure.

According to an embodiment, the rear end of the percussion piston is provided with a fastening point allowing a separate fitting tool to be connected to the rear end of the percussion piston. A rearmost end surface of the percussion piston may be provided with the fastening point. The rear end of the percussion piston may comprise connecting threads or bayonet coupling means, for example.

According to an embodiment, the percussion piston is provided with at least one fastening point on a circumference surface of the rear end portion of the percussion piston. The fastening point may be a notch, groove or other suitable recess wherein a fitting tool may clamp. The fitting tool may have one or more gripping jaws that may protrude into the one or more recesses formed on the side surface of the percussion piston. The rear most end of the percussion piston may be without any fastening point.

According to an embodiment, the impact device is mounted inside a frame of a breaking device, such as a drilling machine or a breaking hammer, as one single piece comprising at least a percussion piston and a bush. Thus, this embodiment relates to a method of mounting the impact device. The method includes removing a rear cover of the frame and inserting the impact device by axial movement inside the frame. The breaking device may be turned to a vertical position where the rear end of the frame is directed upwards. The mentioned turning may be executed by means of a boom of a work machine.

The rear end of the percussion piston is connected to a lifting device and then the impact device is lifted above the rear end of the frame of the breaking device. The percussion piston is positioned coaxially on the center line of the frame and then the impact device is moved downwards towards the space inside the frame by means of the lifting device. The bushing, the percussion piston, bearings and seals all penetrate inside the frame. When the mounting of the impact device is complete, the rear cover is mounted. In this embodiment the percussion piston supports the bush vertically during the mounting and prevents the bush from dropping downwards. In other words, the bush is hanging from the percussion piston. In order to facilitate mounting, outer surface of the bush may be designed and dimensioned so that the front end of the bush has smaller outer dimensions than the rear end. Thus, the outer surface of the bush may taper towards the front end. The bush may comprise three successive sections having diameters that differ from each other, as is already disclosed above in this application.

The above-disclosed embodiments may be combined to form suitable solutions provided with necessary features disclosed.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE FIGURES

FIG. 1 is a side view showing a rock drilling machine arranged on a feed beam.

FIG. 2 is a side view showing a breaking hammer arranged to a distal end of a boom of an excavator.

FIG. 3 is a schematic sectional view showing a rear portion of a breaking device including an impact device.

FIG. 4 is a schematic cross-sectional view showing an impact device of FIG. 3 and including a bush and a percussion piston arranged inside the bush.

FIG. 5 is a schematic cross-sectional view showing a rear portion of another breaking device.

FIG. 6 is a schematic detailed view of cross-section taken along line C-C shown in FIG. 5.

FIG. 7 is a schematic cross-sectional view showing an impact device of FIG. 5 and including a bush and a percussion piston arranged inside the bush.

FIGS. 8a and 8b are schematic views showing a mounting principle of an impact device.

FIG. 9 is a chart presenting features relating to dismounting of an impact device.

FIG. 10 is a chart presenting features relating to mounting of an impact device.

FIG. 11 is a schematic cross-sectional view showing a rear portion of an alternative breaking device comprising an impact device.

FIG. 12 is a schematic cross-sectional view showing dismounting of the impact device shown in FIG. 11.

For the sake of clarity, the figures show some embodiments of the disclosed solution in a simplified manner. In the figures, like reference numerals identify like elements.

### DETAILED DESCRIPTION OF THE EMBODIMENTS

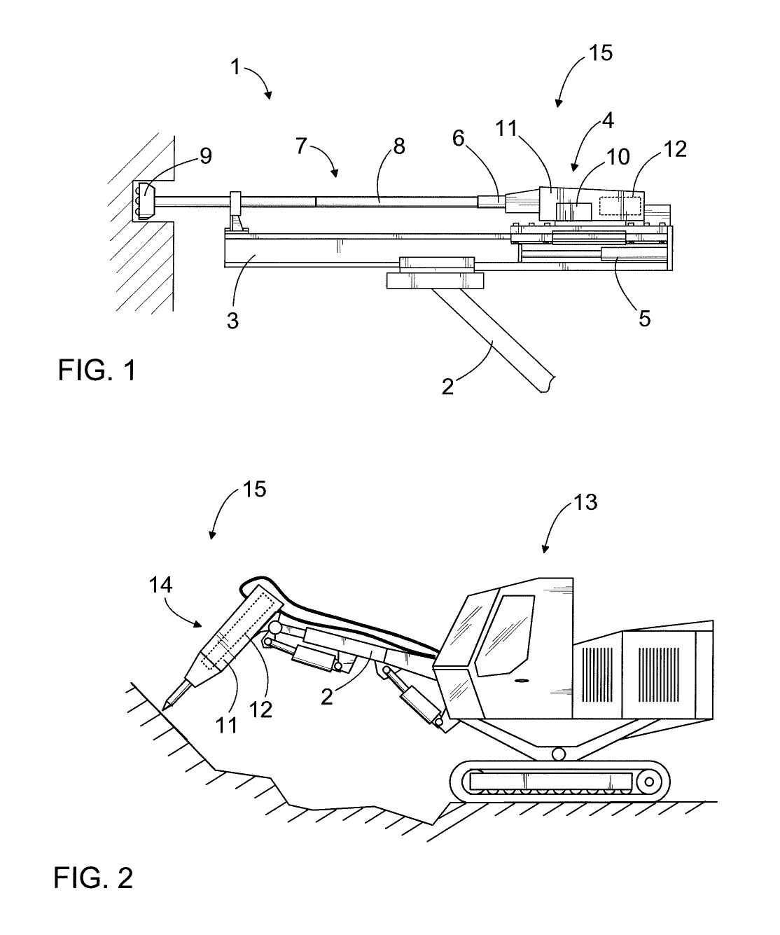

FIG. 1 shows a feasible rock drilling unit 1, which may be connected by means of a boom 2 to a movable carrier, which is not shown. The drilling unit 1 may include a feed beam 3 and a rock drilling machine 4 supported on it. The rock drilling machine 4 may be moved on the feed beam 3 by means of a feed device 5. The rock drilling machine 4 includes a shank 6 at a front end of the rock drilling machine 4 for connecting a tool 7. The tool 7 may include one or more drill rods 8 and a drill bit 9 located at a distal end of the tool 7. The rock drilling machine 4 may further include a rotating device 10 for rotating the shank 6 and the tool 7 connected to the shank 6. Inside a frame 11 of the rock drilling machine 4 is an impact device 12 has a reciprocating percussion piston for generating impact pulses to the tool 7. At a drilling site, one or more drill holes are drilled with the drilling unit 1. The drill holes may be drilled in a horizontal direction, as shown in FIG. 1, or in a vertical direction. The disclosed solution is known as top-hammer drilling. The features disclosed herein may be applied in such drilling machines.

In an alternative drilling solution, which is known as down-the-hole or DTH-drilling, the impact device is located inside a bore hole. The impact device and a rotating device are located at opposite ends of the drilling equipment. The features disclosed herein may also be applied in drilling machines of this type.

FIG. 2 discloses an excavator 13 provided with a boom 2. At a distal end of the boom 2 there is a breaking hammer 14, which has an impact device 12 arranged inside a frame 11 of the breaking hammer 14. The impact device 12 may be in accordance with the solution disclosed herein.

In FIGS. 1 and 2, two different breaking devices 15, namely a rock drilling machine 4 and a breaking hammer 14, are shown. As already mentioned above, the impact device 14 of the breaking device 15 may be in accordance with the disclosed solution and include the features disclosed above. The frame 11 of the breaking device 15 may also include the features disclosed herein.

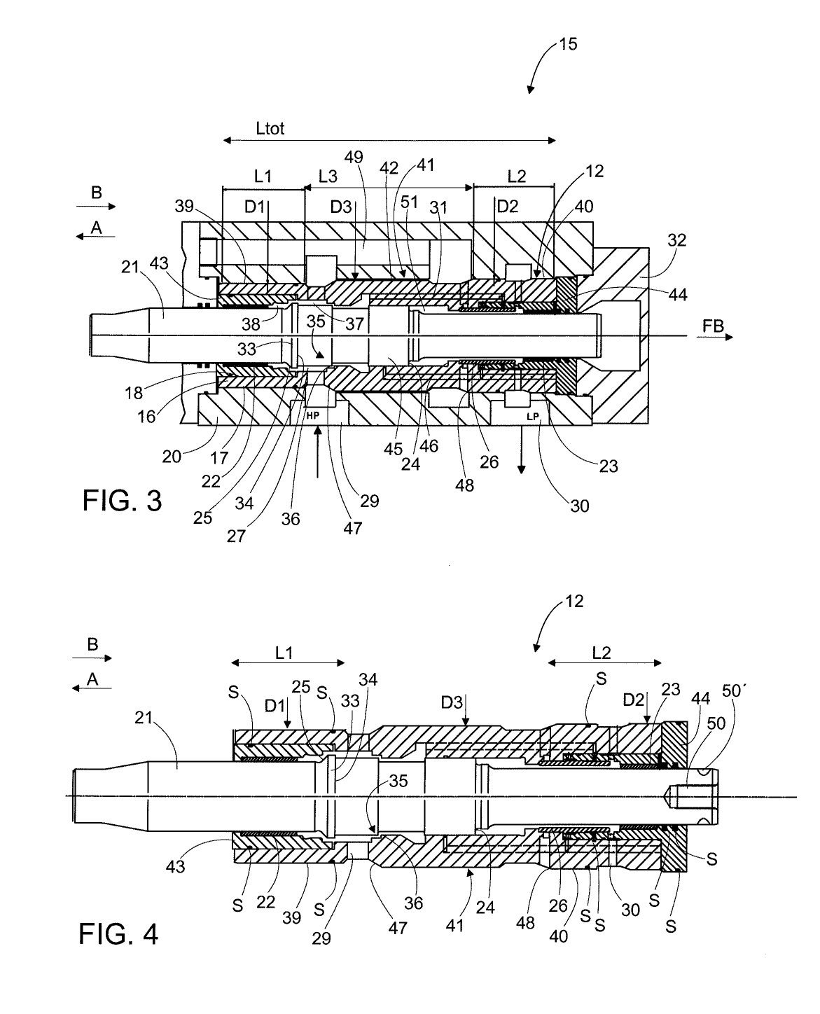

FIG. 3 shows a rear portion of a breaking device 15 having an impact device 12. The impact device 12 includes a bush 16 which is a sleeve-like piece. The bush 16 is an elongated object and has a total axial length Lₜₒₜ, an outer surface 17 and an inner surface 18. The bush 16 is arranged inside an impact device space, which is located at the rearmost end of a frame 20 of the breaking device 15. Inside the bush 16 is a percussion piston 21, which is supported to the bush 16 by means of a front bearing 22 and a rear bearing 23. During operation the percussion piston 21 is moved forwards in an impact direction A for striking a tool and is moved backwards in a return direction B. Thus, the percussion piston 21 is reciprocating during a work cycle of the impact device 12.

The impact device 12 is hydraulically operated whereby the percussion piston 21 includes one or more first working pressure surfaces 24 affecting in the impact direction A and one or more second working pressure surfaces 25 affecting in the return direction B. The percussion piston 21 is moved back and forth by changing hydraulic pressure acting on the working pressure surfaces. In the solution disclosed in FIG. 3 pressure affecting the first working pressure surfaces 24 is controlled by means of a control valve 26. However, hydraulic pressure affecting the second working pressure surfaces 25 is not varied by the control valve 26.

The impact device may also be constructed so that pressure affecting in a front pressure chamber 27 is varied, as well as pressure in a rear pressure chamber 51, for implementing the work cycle of percussion piston.

Hydraulic pressure medium is fed from a hydraulic system to a feed duct or port 29 and the pressure medium is discharged from the impact device through a discharge duct or port 30. The control valve 26 may be a sleeve-like piece arranged around the rear end portion of the piston 21. The control valve 26 may slide in the impact direction A and return direction B in an annular valve space arranged between the inner surface of the bush 16 and the percussion piston 21. The control valve 26 may be pressure controlled whereby it is provided with pressure surfaces, and pressure medium is directed to the these pressure surfaces for moving the sliding valve between front and rear positions according to the working cycle.

The bush 16 includes radial openings at the control valve space for directing pressure medium flows controlled by the control valve 26. The bush 16 may further include one or more axial control pressure ducts 31 for directing pressure medium to control pressure surfaces of the control valve 26. The control of the working cycle of the impact device 12 is known to skilled persons and is therefore not described in more detail in the present disclosure.

The impact device 12 is construed so that the bush 16 may be extracted from the impact space inside the frame 20 by means of the percussion piston 21. Therefore, the rear end of the frame 20 is provided with a rear cover 32, or a corresponding rear element, which closes the rear end of the frame 20. When the rear cover 32 is removed, the impact device 12 can be pulled out by directing an axial dismounting force FB to the rear end portion of the percussion piston 21. The dismounting force FB is external to the impact device, which in practice means that the percussion piston 21 is pulled by means of a lifting device or a corresponding actuator or auxiliary device.

In order to transmit the dismounting force FB from the percussion piston 21 to the bush 16, the percussion piston 21 is provided with a pull shoulder 33. The pull shoulder 33 is located somewhere behind the front bearing 22. In the solution disclosed in FIG. 3 the pull shoulder 33 is in the front pressure chamber 37. Alternatively, the pull shoulder 33 may be located in a middle section or even in a rear end section of the percussion piston 21, depending on the location of the control valve 26 and the basic structure of the impact device 12. In order words, the pull shoulder may be located between the front bearing 22 and the rear end of the percussion piston 21. The pull shoulder 33 includes an axial first counter surface 34 facing the return direction B. The inner surface 18 of the bush 16 is provided with a counter section 35 having a second counter surface 36 facing the impact direction A. When the percussion piston 21 is pulled in the return direction B, the percussion piston 21 moves relative to the bush 16 and the first counter surface 34 becomes into contact with the second counter surface 36 of the bush 16. Then, the force effect of the dismounting force FB is transmitted from the percussion piston 21 to the bush 16 causing the percussion piston 21 and the bush 16 to move together axially in the return direction B. The outer dimension of the pull shoulder 33 is greater than the inner dimension of the counter section 35, whereby the percussion piston 21 may not be pulled completely out of the bush 16 in the return direction B. The pull shoulder 33 may form a closed space 38 when the percussion piston 21 moves close to a forward extreme position.

The bush 16 may be supported to the frame 20 by means of support surfaces 39 and 40 on the outer surface 17 of the bush 16. A first support surface 39 is at the front end portion of the bush 16 and a second support surface 40 is at the rear end portion of the bush 16. The first support surface 39 has a first axial length L1 and a first diameter D1. The second support surface 40 has a second axial length L2 and a second diameter D2. The first length L1 and the second length L2 may be equal or the lengths may differ from each other. The first diameter D1 is smaller than the second diameter D2, whereby the bush 16 has a narrow front end and a wide rear end. Between the first support surface 39 and the second support surface 40 may be an intermediate section 41, which has a third axial length L3 and third outer diameter D3. The frame 20 includes an impact device space wherein the bush 16 is arranged. The frame 20 includes in the impact device space surfaces that are dimensioned to correspond with the diameters D1 and D2 of the bush 16 so that the bush 16 is supported firmly in place when being mounted inside the impact device space. However, the third diameter D3 may be dimensioned so that between the frame 20 and the outer surface of the intermediate section 41 remains a clearance 42. The clearance 42 facilitates mounting and dismounting of the impact device 12.

FIG. 3 further shows that at the front end of the bush 16 may be a front bearing module 43 having a supporting body and the front bearing 22. Correspondingly, the rear end of the bush 16 may include a rear bearing module 44 having a supporting body and the rear bearing 23.

The bearing modules 43 and 44 may also have one or more seals. The bearing modules 43 and 44 may be extracted simultaneously with the percussion piston 21 and the bush 16. Alternatively, the front bearing module 43 may be construed and supported in such a way that it is not extracted together with the other components of the impact device 12. In this alternative embodiment the front bearing module 43 is dismounted in a separate step.

In an additional alternative embodiment the pull shoulder 33 may be located elsewhere, as compared to the embodiment shown in FIG. 3. Thus, a shoulder 45 may serve as a pull shoulder and the working pressure surface 24 may then serve as a first counter surface. When the percussion piston is pulled in the return direction during the dismounting procedure, then the surface 24 abuts a surface 46 of the bush 16. In this embodiment the first counter surface of the pull shoulder serves during the normal operating cycle of the impact device 12 as a dampening component, since the shoulder 45 forms a closed dampening space when the percussion piston 21 moves to an extreme rear position.

FIG. 3 also shows that the bush 16 includes pressure surfaces 47 and 48, which are connected to the feed duct 29, either directly or by means of one or more axial pressure channels 49. The pressure surfaces 47 and 48 produce an axial force in the return direction B when the impact device 12 is pressurized. The pressure surface 47 exists because of a difference in diameters D1 and D3, and correspondingly the pressure surface 48 exists because the diameter D2 is greater than the diameter D3. Due to the pressure surfaces and the generated force, the bush 16 is pushed continuously towards the rear cover 32 during the operation. Thus, the bush is always positioned in an accurate position and the impact device operates as designed.

Let it be mentioned that herein the terms front and front direction mean impact direction A, and the terms rear and rear direction mean return direction B.

FIG. 4 shows that the rear end of the percussion piston 21 may include a fastening point 50 allowing a fitting tool to be connected to the rear end of the piston 21. The fastening point 50 may have an axial blind opening with inner threads, for example. Alternatively, the rear end portion of the percussion piston 21 may include one or more fastening points 50′ on circumferential side surfaces.

The fastening point 50′ may be a recess such as a notch or groove, which allows sideward gripping by means of a fitting tool. The fitting tool may include clamping jaws, for example. In FIG. 4 some of the seals S are marked with reference markings. As can be noted in FIG. 4, the impact device 12 may have a modular or cartridge structure that includes all the necessary components in one uniform package. The impact device 12 may be pre-assembled by mounting the rear bearing module 44 to the rear end of the bush 16. Thereafter the rear end of percussion piston 21 may be inserted in the front end of the bush 16 and may be pushed in the rearward direction until the pull shoulder 33 abuts the second counter surface 36. After this, the front bearing module 43 may be mounted to the front end of the bush 16. The bearing modules 43 and 44 are provided with the needed bearings 22, 23 and seals S.

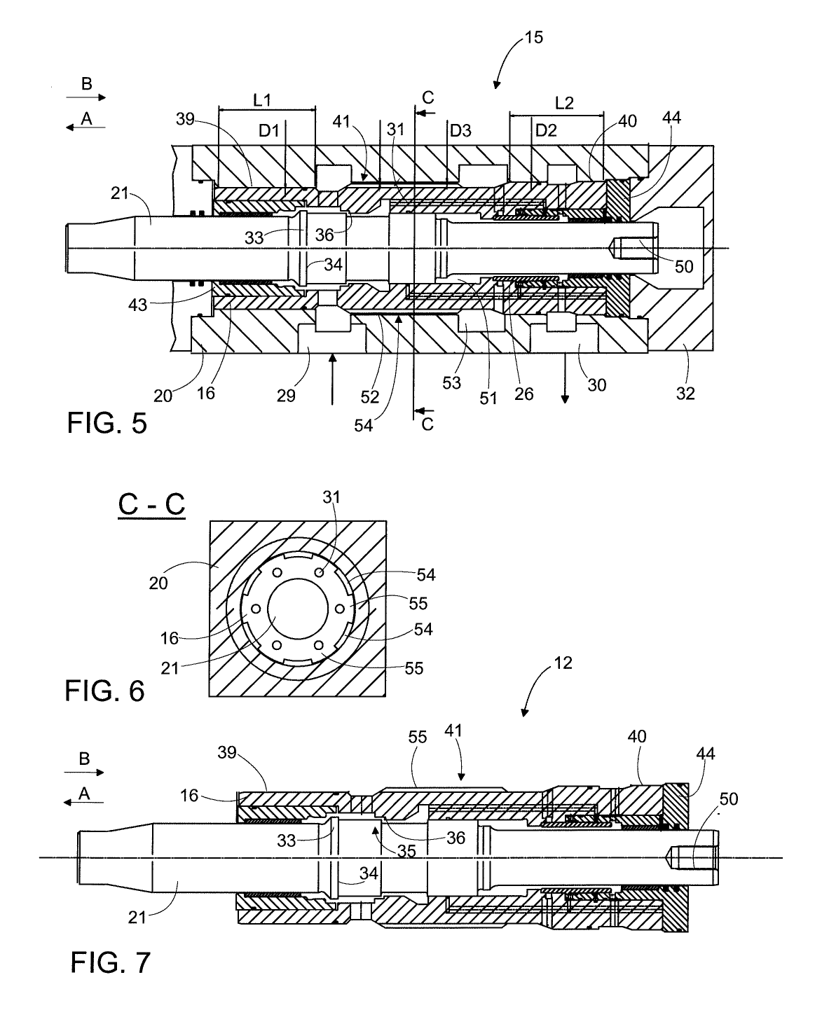

FIGS. 5 to 7 show another embodiment, which has only few differences compared to the solution disclosed in FIGS. 3 and 4. As can be noted, in FIG. 5 the frame 20 does not have the axial pressure channel 49 for conveying pressure medium from the feed port 29 to a rear pressure chamber 51 via the control valve 26. Instead, the intermediate section 41 of the bush 16 is provided with one or more pressure channels 52 allowing pressure medium to flow from the feed port 29 to a space 53 and further under control of the control valve 26 to the rear pressure space 51.

As already discussed above, between the outer surface of the intermediate section 41 and the inner surface of the bush 16 there may be a clearance needed to facilitate the mounting and dismounting of the impact device 12. In addition to the clearance, the outer surface of the intermediate section 41 may include one or more grooves 54 or corresponding flow passages. As shown in FIG. 6 the outer surface of the intermediate section 41 may have splined configuration and may then have several axial grooves 54 between radial splines 55.

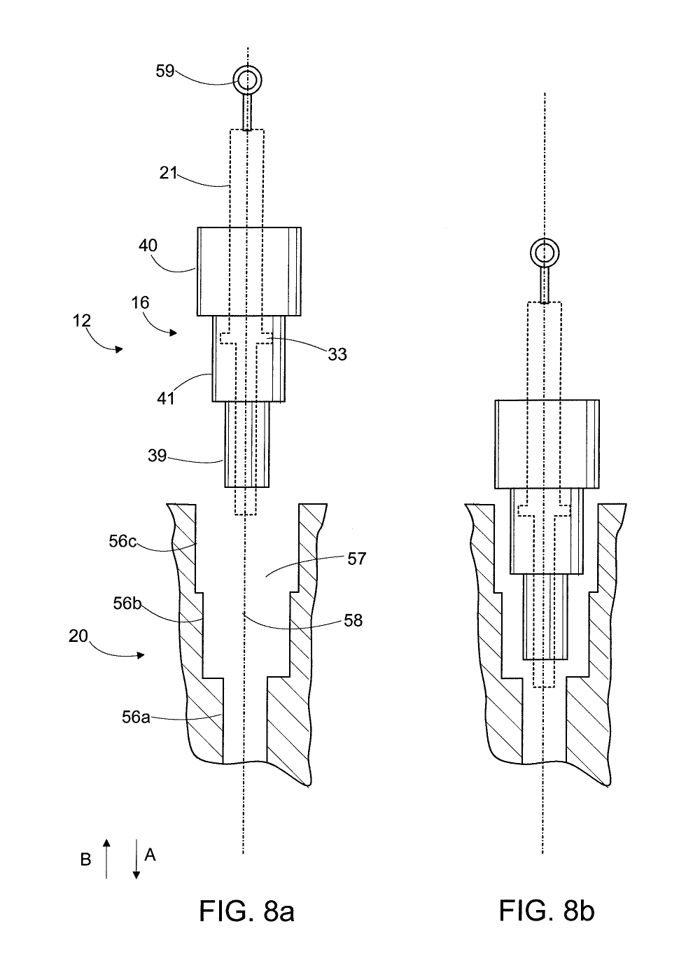

FIGS. 8a and 8b show in a simplified manner a mounting principle of the impact device 12 to the frame 20 of the braking device 15. The outer dimensions of the bush 16, as well as the inner dimensions of supporting surfaces 56a-56c are exaggerated for ease of understanding. The bush 16 tapers towards the front end, which facilitates mounting. The tapered first support surface 39 passes easily through the supporting surfaces 56b and 56c of the frame 20 having greater dimensions.

The mounting may be executed in a vertical position whereby the rear end of the frame is pointing upwards. The rear cover is removed and an impact device space 57 is open to receive the impact device 12. In FIG. 8a the impact device 12 is lifted by means of a lifting device above the frame 20 and is positioned to a center line 58 of the impact device space 57. The bush 16 is supported by the pull shoulder 33 of the percussion piston 21. A fitting tool 59 is attached to the rear end of the percussion piston 21 enabling the lifting and handling of the impact device by means of the lifting device.

In FIG. 8b the impact device 12 is lowered and the impact device 12 has penetrated into the impact device space 57.

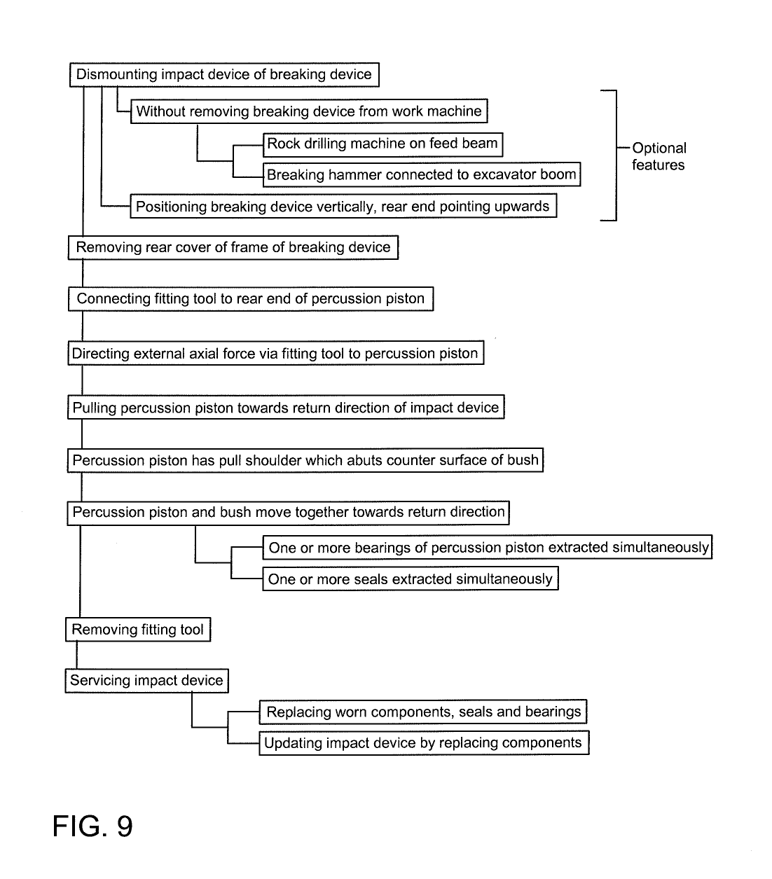

FIG. 9 shows a chart wherein some steps and features, described above, relating to dismounting of an impact device are shown.

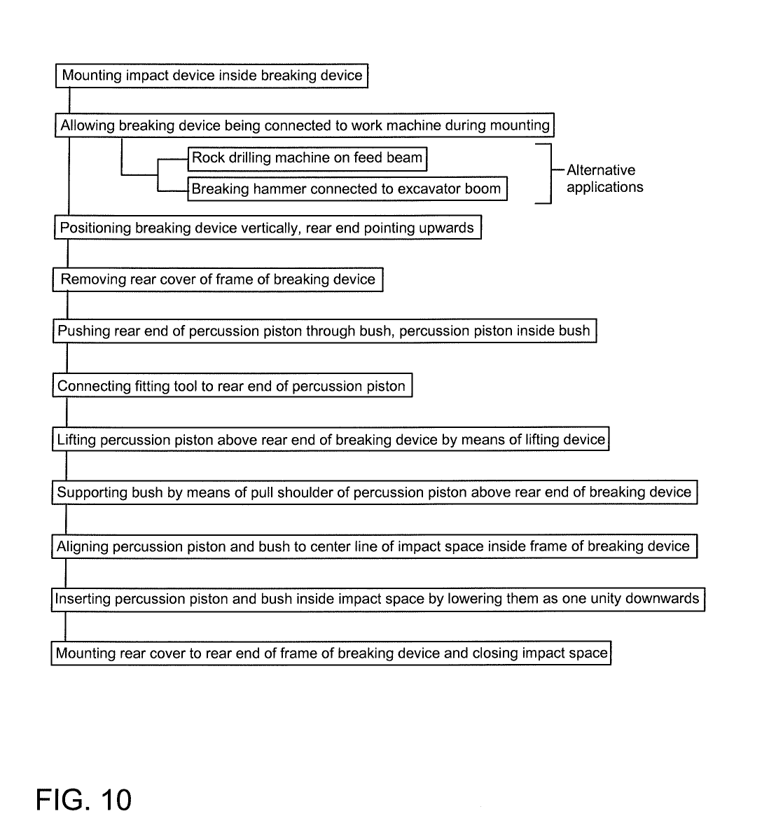

FIG. 10 shows a chart, wherein some steps and features, described above, relating to mounting of an impact device are shown.

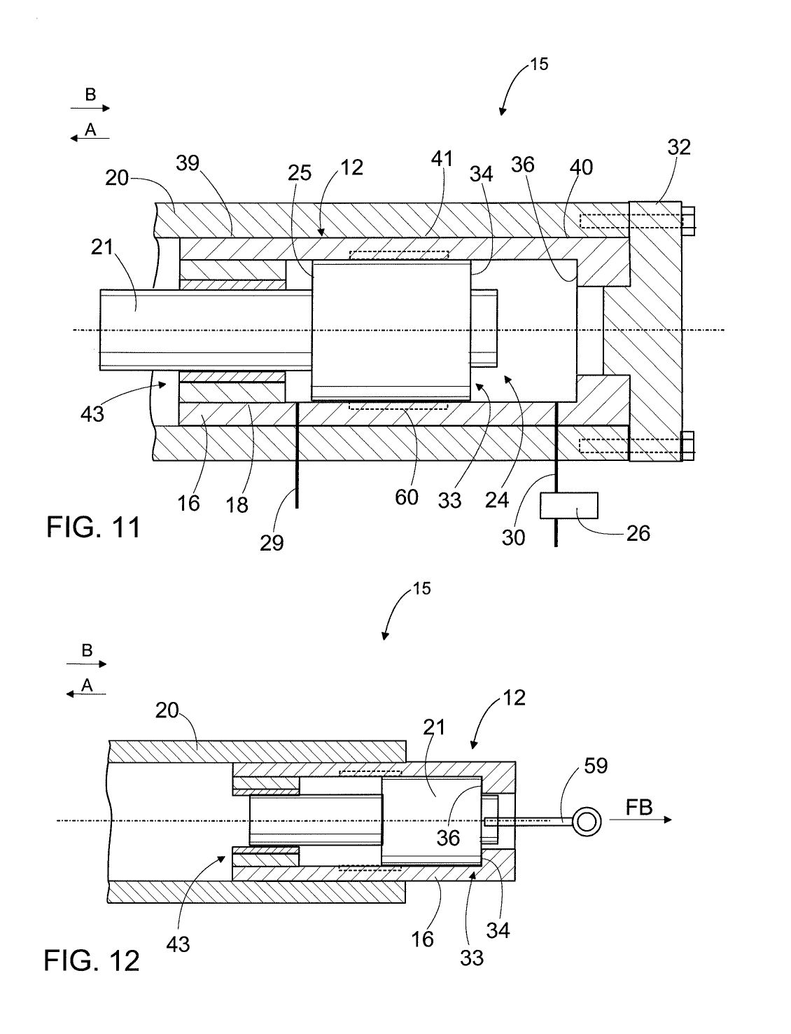

FIG. 11 shows an alternative impact device 12 and bush 16. The above disclosed principles and features apply also in the solution of FIG. 11. However, in the disclosed impact device 12, the percussion piston 21 may be bearing mounted to the bush 16 without any special rear bearing element. Alternatively, an inner surface 18 of the bush 16 may be provided with an integrated bearing portion 60. Another difference is that the control valve 26 may be arranged outside the bush 16. The rear end of the percussion piston 21 has a shoulder, which may serve as a pull shoulder 33.

When the percussion piston 21 is pulled in the return direction B by means of an external dismounting force, a first counter surface 34 of the pull shoulder 33 becomes into contact with a second counter surface 36 of the bush 16. Thus, also in this embodiment the bush 16 may be removed by means of the percussion piston 21. The dismounting of the impact device 12 is shown in FIG. 12.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

1. An impact device comprising:
a percussion piston, which is an elongated object provided with at least one first working pressure surface for moving the percussion piston in an impact direction by a pressure medium, and at least one second working pressure surface for moving the percussion piston in a return direction, the percussion piston including a front end facing towards the impact direction and a rear end facing towards the return direction;
a bush, which is an elongated object provided with an outer surface and an inner surface, wherein the percussion piston is located inside the bush;
at least one bearing for supporting the percussion piston in the bush;
pressure medium ducts for connecting the working pressure surfaces of the percussion piston to a pressure medium system; and
at least one pull shoulder having an outer diameter and a first counter surface facing towards the return direction, the inner surface of the bush being provided with at least one counter section located between the pull shoulder and a rear end of the bush, the counter section having an inner diameter, and a second counter surface facing towards the impact direction wherein the outer diameter of the pull shoulder is greater than the inner diameter of the counter section, and wherein the first counter surface of the pull shoulder and the second counter surface of the counter section abut when the percussion piston is pulled in the return direction.

2. The impact device as claimed in claim 1, further comprising at least one front bearing at the front end portion of the percussion piston for supporting the percussion piston to the bush the pull shoulder being located between the front bearing and the rear end of the percussion piston.

3. The impact device as claimed in claim 1, wherein the inner diameter of the counter section is the smallest diameter in the inner surface of the bush.

4. The impact device as claimed in claim 1, wherein the pull shoulder and the counter section form a closed pressure space between the percussion piston and the bush when the percussion piston is moved to an extreme position in the return direction, the closed pressure space serving as an end cushion in the return direction during an operating cycle of the impact device.

5. The impact device as claimed in claim 1, further comprising at least one control valve for controlling pressure medium affecting working pressure surfaces of the percussion piston, wherein the control valve is a sleeve-like piece and is located in an annular space between the percussion piston and the bush.

6. The impact device as claimed in claim 1, wherein the outer surface of the bush is provided with two circular support surfaces located at an axial distance from each other and both outer diameters, the front end of the bush being provided with a first support surface and the rear end being provided with a second support surface, the first support surface having a first axial length and the second support surface having a second axial length, the outer surface of the bush being provided with an intermediate section between the first support surface and the second support surface, the diameter of the first support surface being smaller than the diameter of the second support surface, and a diameter of the intermediate section being smaller than the diameter of the second support surface.

7. The impact device as claimed in claim 6, wherein the bush has an axial length which is at least double the greatest axial length of either of the first support surface and the second support surface.

8. The impact device as claimed in claim 1, wherein the rear end portion of the percussion piston is provided with at least one fastening point, a fitting tool being connectable to the percussion piston.

9. A rock drilling machine comprising:
a frame;
an impact device located inside the frame, the impact device including a percussion piston, which is an elongated object provided with at least one first working pressure surface for moving the percussion piston in an impact direction by a pressure medium, and at least one second working pressure surface for moving the percussion piston in a return direction, the percussion piston including a front end facing towards the impact direction and a rear end facing towards the return direction; a bush, which is an elongated object provided with an outer surface and an inner surface, wherein the percussion piston is located inside the bush; at least one bearing for supporting the percussion piston in the bush; pressure medium ducts for connecting the working pressure surfaces of the percussion piston to a pressure medium system; and at least one pull shoulder having an outer diameter and a first counter surface facing towards the return direction, the inner surface of the bush being provided with at least one counter section located between the pull shoulder and a rear end of the bush, the counter section having an inner diameter, and a second counter surface facing towards the impact direction, wherein the outer diameter of the pull shoulder is greater than the inner diameter of the counter section, and wherein the first counter surface of the pull shoulder and the second counter surface of the counter section abut when the percussion piston is pulled in the return direction; and
a rotating device.

10. The rock drilling machine as claimed in claim 9, wherein the frame includes a rear end, which is provided with a rear cover, and the bush inside the frame is extracted by the percussion piston in the return direction when the rear cover is removed.

11. A breaking hammer comprising:
a frame and
an impact device disposed inside the frame the impact device including a percussion piston, which is an elongated object provided with at least one first working pressure surface for moving the percussion piston in an impact direction by a pressure medium, and at least one second working pressure surface for moving the percussion piston in a return direction, the percussion piston including a front end facing towards the impact direction and a rear end facing towards the return direction; a bush, which is an elongated object provided with an outer surface and an inner surface, wherein the percussion piston is located inside the bush; at least one bearing for supporting the percussion piston in the bush; pressure medium ducts for connecting the working pressure surfaces of the percussion piston to a pressure medium system; and
at least one pull shoulder having an outer diameter and a first counter surface facing towards the return direction, the inner surface of the bush being provided with at least one counter section located between the pull shoulder and a rear end of the bush, the counter section having an inner diameter, and a second counter surface facing towards the impact direction, wherein the outer diameter of the pull shoulder is greater than the inner diameter of the counter section, and wherein the first counter surface of the pull shoulder and the second counter surface of the counter section abut when the percussion piston is pulled in the return direction.

12. The breaking hammer as claimed in claim 11, wherein the frame includes a rear end, which is provided with a rear cover; and the bush inside the frame is extracted by the percussion piston in the return direction when the rear cover is removed.

13. A method of dismounting an impact device from a breaking device, wherein the breaking device includes at least a frame, an impact device arranged inside the frame and a rear cover at a rear end of the frame, and wherein the impact device includes at least a bush and a percussion piston inside the bush, the method comprising:
removing the rear cover;
dismounting the impact device from inside the frame in a return direction of the impact device;
generating an external axial dismounting force in the return direction of the impact device and directing the external dismounting force to the percussion piston during the dismounting; and
extracting the bush outside the frame by the percussion piston.

14. The method according to claim 13, further comprising dismounting the impact device as one single object the bush, the percussion piston, and bearings and seals between the percussion piston and the bush.

15. The method according to claim 13, further comprising dismounting the impact device while the frame of the breaking device is fastened to a work machine.

16. The method as claimed in claim 13, further comprising the steps of connecting a separate fitting tool to the rear end portion of the percussion piston; transmitting the dismounting force via the fitting tool to the percussion piston; and transmitting the dismounting force by means of at least one pull shoulder in the percussion piston to at least one counter surface inside the bush.
